(19) United States
(12) Patent Application Publication
(10) Pub. No.: US 2023/0298071 A1
(43) Pub. Date: Sep. 21, 2023

(54) FACILITATING COMMERCIAL SALES VIA ACCURATE MOBILE DEVICE LOCATION SENSING

(71) Applicant: AT&T Intellectual Property I, L.P., Atlanta, GA (US)

(72) Inventors: Zhi Cui, Sugar Hill, GA (US); Hongyan Lei, Plano, TX (US)

(21) Appl. No.: 17/655,305

(22) Filed: Mar. 17, 2022

(51) Int. Cl. G06Q 30/02; G06T 19/00; H04W 4/23; H04W 4/021; G06Q 20/20

(52) U.S. Cl. CPC G06Q 30/0268; G06Q 20/20; G06Q 30/0261; G06T 19/006; H04W 4/021; H04W 4/23

(57) ABSTRACT

Described is facilitating sales of products and services based on the detection of the presence of mobile devices within a defined region corresponding to a point-of-sale location, determined via accurate mobile device location sensing, e.g., within on the order of one meter. Upon detection of the presence of a mobile device within a defined point-of-sale region via mobile device millimeter wave-based position sensing, one or more actions to facilitate a sale can be taken. This can include sending targeted advertising to the mobile device to incentivize the sale, with the targeted advertising based on user profile data when available. Another action can be to summon personnel to the sensed location to facilitate a sale. Movement determined by change of location and other data can be evaluated to determine whether a person (via his or her mobile device) is remaining in a defined point-of-sale region or is only passing through.

### TECHNICAL FIELD

The subject application relates to wireless communications systems in general, and more particularly to more accurate location sensing based on advanced networks, such as, but not limited to, New Radio (NR) including fifth generation (5G) cellular wireless communications systems and/or other next generation networks.

### BACKGROUND

In fifth generation (5G) wireless networks, new features are regularly being developed. According to standards of the third generation partnership project (3GPP) release 17, one such wireless network feature is positioning enhancements. These positioning enhancements, which can be based on millimeter wave-based position sensing, aim to improve the accuracy of mobile device (user equipment or UE) location from what is now on the order of 50 meters to on the order of 1.0 meter for commercial UE devices and less than 0.2 meters for industrial internet of things (IIoT) devices. As a result, services for various scenarios have been and can be developed based on such relatively highly accurate mobile device location sensing.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram representation of an example network communication system in which accurate mobile device location sensing can detect a mobile device’s proximity to a potential point-of-sale location, in accordance with various aspects and embodiments of the subject disclosure.

FIG. 2 is a top view representation of a floor plan in which various zones (defined regions) have been established for taking sales-related action(s) based on the detected presence of mobile device(s) within the zones, in accordance with various aspects and embodiments of the subject disclosure.

FIG. 3 is a top view representation of a floor plan in which various zones (defined regions) have been established for taking sales-related action(s) based on the detected movement of mobile device(s) within the zones, in accordance with various aspects and embodiments of the subject disclosure.

FIG. 4 is a flow diagram illustrating example operations that can be performed in response to detecting a mobile device within a defined region, in accordance with various aspects and embodiments of the subject disclosure.

FIG. 5 is a flow diagram illustrating example operations that can be performed to facilitate a sale at a point-of-sale (POS location), in accordance with various aspects and embodiments of the subject disclosure.

FIG. 6 illustrates example operations related to taking action, based on accurate location information of a mobile device, to facilitate a commercial sale to a potential customer, in accordance with various aspects and embodiments of the subject disclosure.

FIG. 7 illustrates example operations related to taking action, based on accurate location information of a mobile device and commercial data, to facilitate a commercial sale to a potential customer, in accordance with various aspects and embodiments of the subject disclosure.

FIG. 8 illustrates example operations related to taking action in response to determining that a mobile device is located at a point-of-sale location for at least a defined length of time, in accordance with various aspects and embodiments of the subject disclosure.

FIG. 9 illustrates an example block diagram of an example mobile handset operable to engage in a system architecture that facilitates wireless communications according to one or more embodiments described herein.

FIG. 10 illustrates an example block diagram of an example computer / machine system operable to engage in a system architecture that facilitates wireless communications according to one or more embodiments described herein.

### DETAILED DESCRIPTION

The technology described herein is generally directed towards accurately locating (e.g., within approximately one meter) the presence of a mobile device at or near (e.g., approaching) a point-of sale location, and taking action to facilitate a sale based on that location. As one non-limiting example, the technology described herein is able to locate a mobile device of a customer at a particular sales counter within a large department store.

In one available alternative, based on the highly accurate location data targeted advertising using a network-based location application and service can be performed to help facilitate a sale. The advertisement can be at a relatively fine granular level, such as tailored to customers or other audiences based on users who have visited a specific brand or category, and/ or based on patterns that match one or more behaviors associated with specific behavioral groups.

In another available alternative, based on the highly accurate location data, personnel can be summoned to the location to help facilitate a sale. For example, this can be a representative of a particular brand located at that brand’s sales counter area, or can be a general purpose salesperson who can finalize a sale.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNodeB (gNB),” “evolved Node B (eNodeB),” “home NodeB (HNB)” and the like, can be utilized interchangeably in the application, and can refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

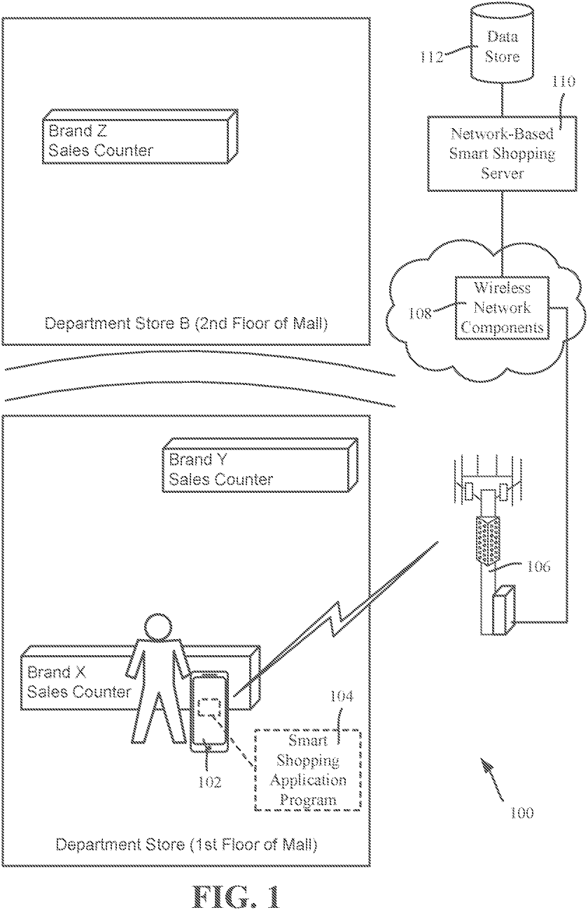

Turning to the drawings, FIG. 1 shows an example of how the technology described herein can be applied to a shopping mall. Consider a potential customer with a mobile device 102. In this example, the mobile device is running a network-based smart shopping application program 104, however as will be understood, the technology described herein does not require that such a program be installed and/or running to facilitate a sale or other commercial transaction.

In the example of FIG. 1, the potential customer, via the mobile device 102, is accurately sensed by a wireless network (e.g., cell / antenna 106 and wireless network components 108) as being located at a sales counter associated with Brand X. This information is sent to a network-based smart shopping service’s (a server thereof) 110, which can determine an action to take. In general, the network-based smart shopping service 110 dynamically updates / maintains the store / product and location information, and the highly accurate location information of the mobile device 102. The network-based smart shopping service 110 can, for example, be powered by artificial intelligence / machine learning, leveraging dynamic or relatively frequent updates of precise user location information.

For example, the wireless network components 108 can derive the location information and user identity data via positioning enhancements capabilities, and pass the location precision information along with a notification message to the network-based smart shopping service 110. The wireless network components 108 can also send data as to the how long the customer stays, and how frequently he or she visits the network-based smart shopping service 110, although the smart shopping service 110 can determine this if receiving the location and identity information relatively frequently.

From the perspective of the seller, a seller can subscribe or otherwise contract with the smart shopping service 110 in order to send targeted advertisements of their products or services when the smart shopping service 110 detects a sales the opportunity, e.g. customers at or approaching a location, or in a nearby store / sales counter shopping similar products. A seller / shop can share its exact locations for its products with the smart shopping service 110. A shop can be an entire department store or can be a counter within the department store.

From the perspective of the customer user (as a potential shopper), the user installs the network-based smart shopping application program 104 with preconfigured or otherwise determinable server address to where the user location information is to be sent when running the smart shopping application program 104. In one implementation, the user agrees to share his or her location information for the purpose of finding the best deals when shopping when the program is running.

In this example, consider that the mobile device 102 is registered with the network-based smart shopping service 110 as belonging to a user of the service. This can be automatic, because the smart shopping application program 104 is running on the device, which in conjunction with the smart shopping service 110 can map to the store and product counter, duration the user stays, and how frequently the user visits.

Based on the accurate location information of the mobile device 102, e.g., sent via the smart shopping application program 104 and/or network components 108, the smart shopping service 110 can extrapolate at which store / counter the subscriber is located, and if appropriate, to which brand of product the customer appears to be interested. Based on the location and customer identity data, the smart shopping service 110 can send one or more targeted advertisements to the customer’s mobile device 102. If unknown, a more general advertisement can be sent to the mobile device. An advertisement can include or be in the form of one or more coupons that will help entice the customer to make a purchase.

For example, in FIG. 1 the customer with mobile device 102 is at Brand X’s sales counter. A targeted advertisement can be sent for Brand X, e.g., “if you buy Product 123 today you get ten percent off!” A different targeted advertisement can be sent for a different brand relative to the current counter, e.g., “Brand Y has basically the same or very similar products at twenty percent off, and you are only a few steps from our counter!” A different brand’s counter is one example; however a different retail store can entice a customer to move from their current location to the other retail location.

As shown in FIG. 1, the smart shopping service 110 is coupled to a data store 112. For example, based on the identity of the customer, various customer profile data can be accessed, such as the shopper’s shopping spending history, level of status (e.g., VIP), membership data and so forth for any other useful criteria. Based on purchase history, movement patters or outside actions such as browsing history, a customer can be fit into one or more group profiles, such as sports enthusiasts, fashion followers, building contractors and so on. Subgroup profiles are also feasible, e.g., sports enthusiasts in a fishing subgroup.

Such information can be used in many ways, including to adjust prioritization / allocate network resources among multiple served shoppers, customize a targeted advertisement, and the like. As one example, a customer who tends to buy one brand of product may be given a larger discount if he or she switches to another product. For example, augmented reality / virtual reality / a remote shopping experience can be used to enhance a targeted advertisement, possibly based on a customer’s actual and/or discerned preference data. As another example, merchandise such as clothing can be displayed in a targeted advertisement to a user in which the clothing appears in a certain color because the customer tends to purchase that color, and/or because advertisements sent with items in that color “catch the user’s eye” and statistically result in better sales relative to advertisements in other colors. Instead of or in addition to augmented reality, virtual reality and/or a remote shopping experience a targeted advertisement can also be enriched with remote stylist feedback, by virtually changing color / design, and so forth.

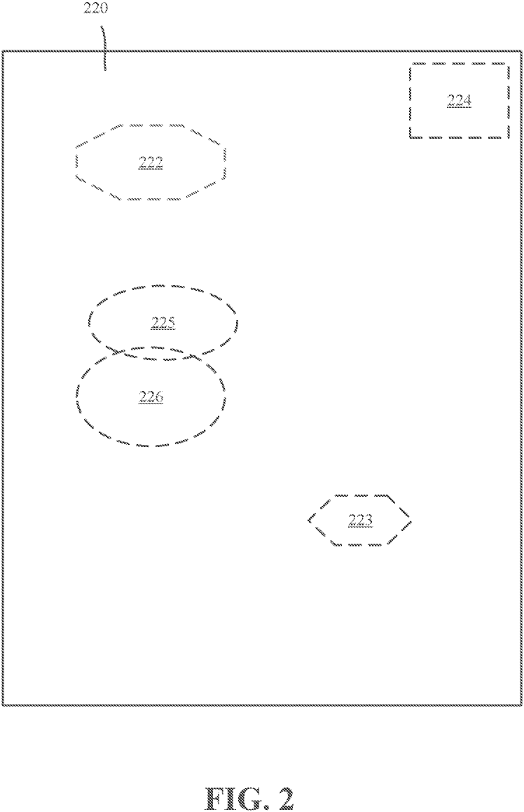

FIG. 2 shows an example of how a store floor 220 or the like may be divided into zones 222 - 226 by defined locations (e.g., coordinates and/or radii), which can be two-dimensional areas or even three-dimensional regions. Any practical shape can be defined, even irregular shapes. A zone can overlap another zone, such as the zones 225 and 226 in the example of FIG. 2. Which zone a user is in when in the intersection portion can be determined by other criteria, such as motion, a tiebreaker scheme (e.g., alternate if stationary), or possibly in both zones with respect to receiving targeted advertising. If detectable via a camera or other sensor, eye gaze or the like can determine which direction a customer is looking which can indicate a zone.

As in the example of FIG. 1, a zone can be a particular brand’s sales counter, but can be defined for other purposes. For example, a potential point-of-sale can be associated with a defined zone; this does not necessarily mean that the actual sale is transacted at the point-of-sale, but can instead mean that when at that zone the customer is enticed to buy a product or service, even if the actual sales transaction is at a different location.

As a more particular example, a customer walking through a grocery store can be pinpointed to which products are within a meter or so of the customer’s mobile device. An advertisement can be sent that causes (at the point of sale) a product to be selected by the customer, even though the customer does not pay for the product until checking out. Similarly, a product or service demonstration can convince a customer to make a purchase from elsewhere in the store, and thus the point of sale can be considered the demonstration area of the chosen product or service.

A zone can be defined for other purposes. For example, consider that stores lock some merchandize in cabinets that require store personnel to unlock to make a purchase. A zone can be defined in front of such a locked cabinet, whereby store personnel can automatically be summoned to help facilitate the sale by unlocking the cabinet. A display or message can be sent to the user to inform the user that help has been summoned. Another option is to activate a camera to view the customer, and remotely unlock the cabinet if the customer appears to be a legitimate customer rather than a possible thief.

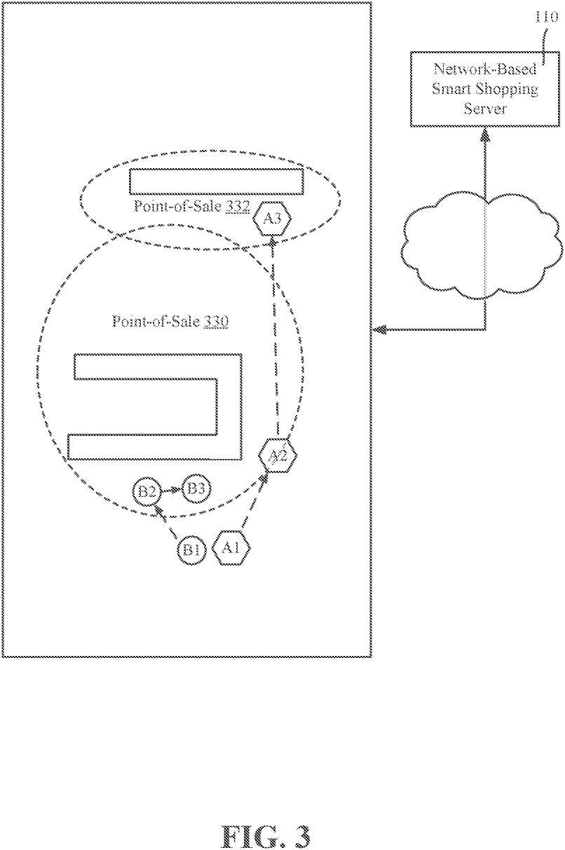

As shown in FIG. 3, by obtaining regularly updated mobile device location information, it is straightforward to intelligently determine if a user is walking past or is waiting at a specific location. For example, consider that a user A is within the point-of-sale zone 330, but is not stopping from location A1 to location A2 until location A3 is reached; note that more frequent location reporting can be used, however this example only shows three locations for purposes of clarity and explanation. Thus, the smart shopping service 110 need only take action when the user A appears to be settled in the zone 332. In contrast, the user B has moved from location B1 to location B2 and is now at location B3, and thus the smart shopping service 110 can take action based on the user B appearing to be settled in the point-of-sale zone 330. As set forth above, targeted advertising can be smart with respect to a shop’s ordered list of point-of-sale zones or the like based on the location the subscriber is at and the direction the user is walking. Food coupons and the like can be sent by food vendors, such as based on the direction a person is walking and the time of day.

Indeed, pacing back-and-forth and/or duration can also be detected (possibly suggesting customer impatience), and other device sensors (e.g., for sensing motion) can provide additional behavioral information. If available, a camera / eye tracking can be activated to determine if a user who appears to be remaining in a zone is looking at a product that requires store personnel to help facilitate a sale, or is likely looking at something else, such as a magazine counter.

Given that many stores are currently understaffed, the technology described herein can help facilitate a sale by summoning personnel as needed. For example, what appears to be an impatient customer who has been standing / pacing within a point-of-sale location for some time can be sent a store employee (or brand representative if appropriate). The service can tie into store employees’ devices, for example, and send messages that indicate where, and if appropriate what type of person is needed (e.g., any salesperson to ring up a sale versus a manager to unlock merchandise; the message can be sent only to manager(s) in such a situation). The summoned personnel can respond that they have the issue handled, so that other personnel know they are not needed. Another usage scenario is when a long line of customers is forming and additional help is desired at a certain location.

Note that users need not have the smart shopping application program 104 running and/or be registered with the smart shopping service 110 to benefit from the technology described herein. Indeed, any mobile device capable of having its location accurately sensed by wireless networking positioning enhancements can be used beneficially to help facilitate a sale (although depending on regulations or the like a user may have to opt into allowing such location data to be used as described herein).

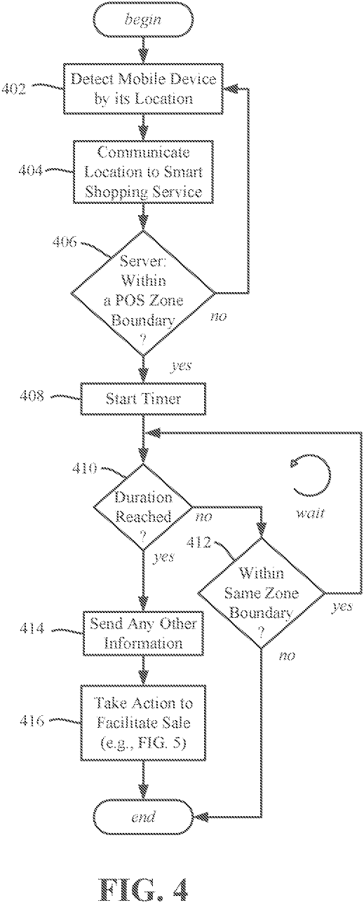

FIG. 4 is a flow diagram showing some example operations based on accurate detection (operation 402) of a mobile device with respect to a point-of-sale boundary. In this example, the smart shopping service 110 obtains the location information from the device’s application program or the wireless network (operation 404), and determines that the mobile device is within a defined zone boundary (operation 406).

In this example, operation 408 starts a timer to measure the duration of the person in that zone; the duration can be based on which zone a user is in. Operation 410 waits for the duration to be reached, during which time operation 412 determines if the user is remaining within the same zone or has left that zone.

If the user is remaining in the zone long enough to satisfy the length of time / duration criterion, operation 414 in the example of FIG. 4 may send additional information to the smart shopping service 110, e.g., sensed mobile device motion data, updated location data (possibly at a faster rate of sending to help detecting pacing or the like). Operation 416 represents taking some action to help facilitate a sale. As described herein, this can be to send targeted advertising, and/or summon personnel based on the current zone and other data, such as user profile data.

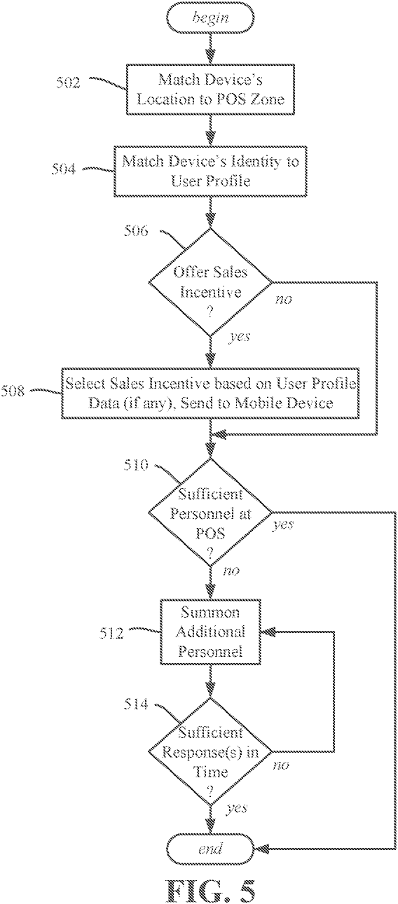

FIG. 5 is a flow diagram showing some example operations of the smart shopping service 110 based on accurate mobile device location data obtained by the service 110. Note that some of the operations can be handled by in-store technology or the like instead of the service, such as if the service is configured to simply provide location information of the number of mobile devices within each defined zone(s).

Operation 502 matches the device’s location to some defined zone, e.g., a product counter as described herein, or some other point-of-sale a location within a store. Operation 504 matches the identity of the device with a user profile. Note that operation 504 can be bypassed if, for example, the identity is irrelevant, hidden from or otherwise unknown to the service, such as in a scenario where store personnel only needs to be summoned to help, without the need for any targeted advertising.

Operation 506 determines whether any sales incentive is to be offered, whether tailored based on user profile data or in general. Note, for example, that generally targeted advertising can be sent to the device’s phone number or the like based on the device’s current location but without any profile information; e.g., a mobile device is located in a zone where there are breakfast cereals on the shelves, so send a manufacturer’s coupon to that mobile device to entice the user to buy a particular brand. If a sales incentive is available and the mobile device identity is known (e.g., not hidden from the service), operation 508 sends the sales incentive, which can be a general advertisement(s), user-profile-based targeted advertisement(s) if the profile data is available, coupon(s), rebate offer(s) and the like.

Another aspect that facilitates a sale is whether one or more sufficient personnel are at the point-of-sale zone, as evaluated by operation 510. What is considered sufficient can be based on how many other devices are detected in the zone as well as how many personnel are working at that time. If not sufficient, operation 512 summons one or more additional personnel, which as set forth herein, can be by general messaging or selective messaging to only those qualified to facilitate the sale. Operation 514 repeats the summoning until the appropriate response or number of responses is received from the summoned personnel.

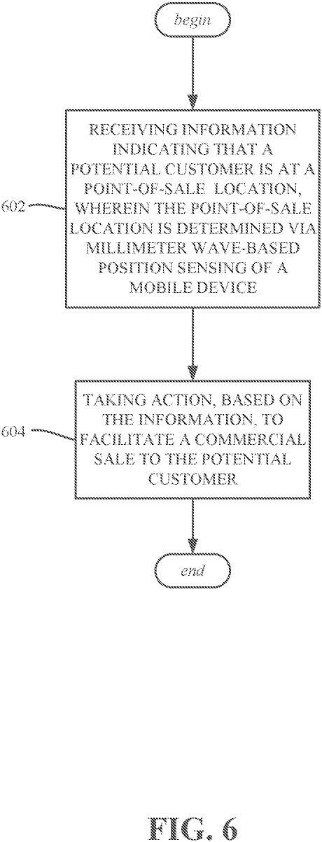

One or more example aspects are represented in FIG. 6, and can correspond to a system, comprising a processor, and a memory that stores executable instructions that, when executed by the processor of the system, facilitate performance of operations. Example operation 602 represents receiving information indicating that a potential customer is at a point-of-sale location, wherein the point-of-sale location is determined via millimeter wave-based position sensing of a mobile device. Example operation 604 represents taking action, based on the information, to facilitate a commercial sale to the potential customer.

Taking the action can include selecting an advertisement based on the potential point-of-sale location, and sending the advertisement to the potential customer via at least one device, comprising the mobile device, associated with a customer identity. Further operations can include modifying the advertisement with at least one of: augmented reality data or virtual reality data.

The mobile device can be associated with a customer identity of the potential customer, and taking the action can include selecting a commercial sale enticement based on the potential point-of-sale location, and sending the commercial sale enticement to the potential customer via at least one device, comprising the mobile device, associated with the customer identity.

Taking the action can include sending a notification to a device associated with a personal identity of a person, other than a customer identity of the potential customer, to notify the person that the potential customer is at the point-of-sale location. The device associated with the personal identity of the person can be a first device associated with a first personal identity of a first person, and further operations can include receiving a communication from the first device that the first person is acting to facilitate the commercial sale, and, in response to receiving the communication, sending a notification to a second device associated with a second personal identity of a second person of the acting to facilitate the commercial sale.

Further operations can include, prior to taking the action, determining that the potential customer is remaining within a defined region proximate to the point-of-sale location for at least a defined length of time.

The point-of-sale location can be a sales counter within a store comprising multiple sales counters. The sales counter can be associated with at least one of: a service or a brand of products.

The point-of-sale location can be a locked merchandise container within a store.

Further operations can include determining a customer identity associated with the mobile device of the potential customer, and taking the action to facilitate the commercial sale to the potential customer can include customizing the action based on the customer identity of the potential customer. Customizing the action based on the customer identity of the potential customer can include customizing the action based on at least one of: spending history data representative of a spending history of the potential customer, status level data representative of a status level of the potential customer, membership data representative of a membership or membership level of the potential customer, prior behavior data representative of a prior behavior of the potential customer, or detected mannerism data representative of a detected mannerism of the potential customer.

Receiving the information indicating that the potential customer is at the point-of-sale location can include receiving location data from a program executing on the mobile device of the potential customer.

Receiving the information indicating that the potential customer is at the point-of-sale location can include deriving location data via the millimeter wave-based position sensing of the mobile device of the potential customer.

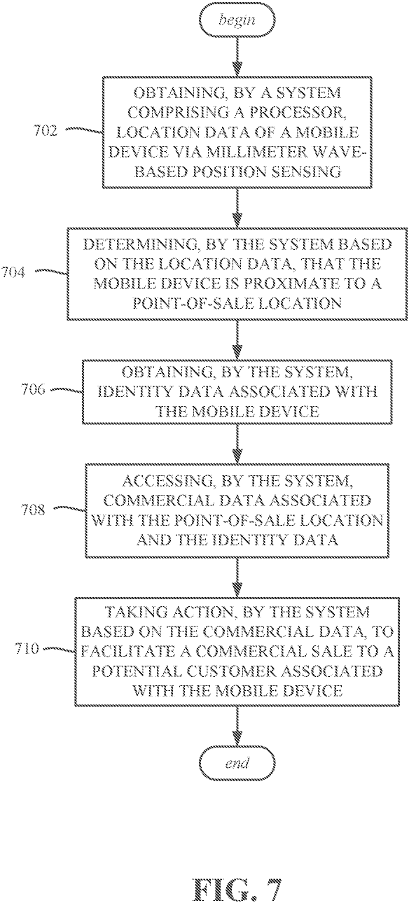

One or more example aspects are represented in FIG. 7, and can correspond to example operations, e.g., of a method. Operation 702 represents obtaining, by a system comprising a processor, location data of a mobile device via millimeter wave-based position sensing. Operation 704 represents determining, by the system based on the location data, that the mobile device is proximate to a point-of-sale location. Operation 706 represents Operation 702 represents obtaining, by the system, identity data associated with the mobile device. Operation 708 represents accessing, by the system, commercial data associated with the point-of-sale location and the identity data. Operation 710 represents taking action, by the system based on the commercial data, to facilitate a commercial sale to a potential customer associated with the mobile device.

Accessing the commercial data associated with the point-of-sale location and the identity data can include selecting at least one of: an advertisement or a coupon based on the point-of-sale location and the identity data, and wherein taking the action can include sending the at least one of the advertisement or coupon to the mobile device.

Taking the action can include sending an entity to the point-of-sale location to perform the commercial sale via a device associated with the entity.

Further operations can include determining, based on a length of time that the mobile device is proximate the point-of-sale location, that the mobile device is associated with a potential customer.

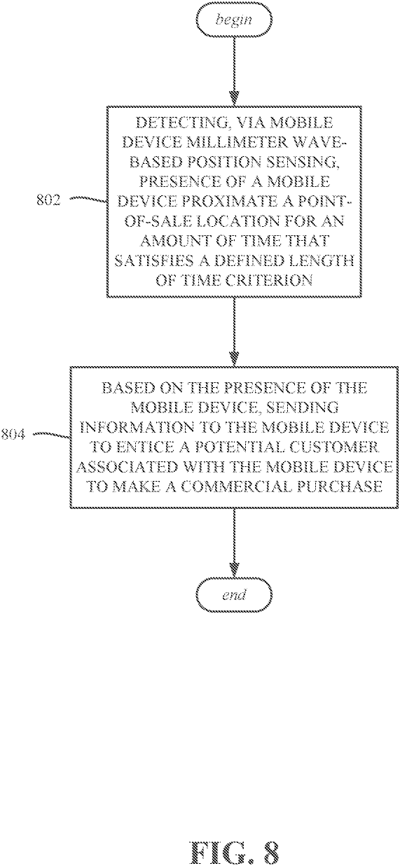

One or more aspects are represented in FIG. 8, such as implemented in a machine-readable medium, including executable instructions that, when executed by a processor, facilitate performance of operations. Example operation 802 represents detecting, via mobile device millimeter wave-based position sensing, presence of a mobile device proximate a point-of-sale location for an amount of time that satisfies a defined length of time criterion. Operation 804 represents based on the presence of the mobile device, sending information to the mobile device to entice a potential customer associated with the mobile device to make a commercial purchase.

Further operations can include sending an entity to the point-of-sale location to facilitate the commercial purchase via a device associated with the entity.

As can be seen, the technology described herein facilitates sales based on accurate mobile device location sensing. General or targeted advertisements at a very granular level can be sent to entice a purchase. Personnel can be summoned to a specific location to assist in making a sale. The technology described thus helps improve end user shopping experiences, as well as help enterprises increase sales.

Turning to aspects in general, a wireless communication system can employ various cellular systems, technologies, and modulation schemes to facilitate wireless radio communications between devices (e.g., a user equipment / UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2 x 2 MIMO scheme, the two antennas can also be used in a diversity configuration rather than MIMO configuration. Even with multiple antennas, a particular scheme might only use one of the antennas (e.g., LTE specification’s transmission mode 1, which uses a single transmission antenna and a single receive antenna). Or, only one antenna can be used, with various different multiplexing, precoding methods etc.

The MIMO technique uses a commonly known notation (M x N) to represent MIMO configuration in terms number of transmit (M) and receive antennas (N) on one end of the transmission system. The common MIMO configurations used for various technologies are: (2 x 1), (1 x 2), (2 x 2), (4 x 2), (8 x 2) and (2 x 4), (4 x 4), (8 x 4). The configurations represented by (2 x 1) and (1 x 2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

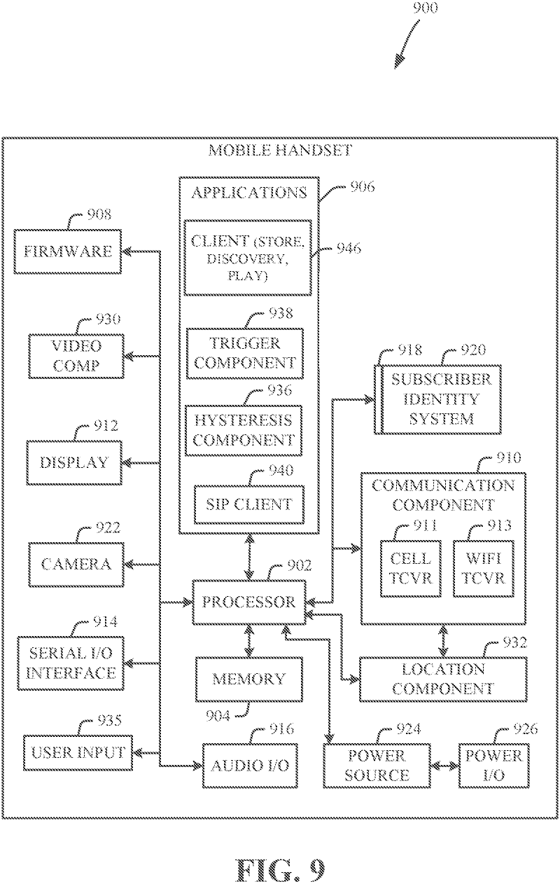

Referring now to FIG. 9, illustrated is a schematic block diagram of an example end-user device (such as a user equipment) that can be a mobile device 900 capable of connecting to a network in accordance with some embodiments described herein. Although a mobile handset 900 is illustrated herein, it will be understood that other devices can be a mobile device, and that the mobile handset 900 is merely illustrated to provide context for the embodiments of the various embodiments described herein. The following discussion is intended to provide a brief, general description of an example of a suitable environment 900 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 900 includes a processor 902 for controlling and processing all onboard operations and functions. A memory 904 interfaces to the processor 902 for storage of data and one or more applications 906 (e.g., a video player software, user feedback component software, etc.). Other applications can include voice recognition of predetermined voice commands that facilitate initiation of the user feedback signals. The applications 906 can be stored in the memory 904 and/or in a firmware 908, and executed by the processor 902 from either or both the memory 904 or/and the firmware 908. The firmware 908 can also store startup code for execution in initializing the handset 900. A communications component 910 interfaces to the processor 902 to facilitate wired/wireless communication with external systems, e.g., cellular networks, VoIP networks, and so on. Here, the communications component 910 can also include a suitable cellular transceiver 911 (e.g., a GSM transceiver) and/or an unlicensed transceiver 913 (e.g., Wi-Fi, WiMax) for corresponding signal communications. The handset 900 can be a device such as a cellular telephone, a PDA with mobile communications capabilities, and messaging-centric devices. The communications component 910 also facilitates communications reception from terrestrial radio networks (e.g., broadcast), digital satellite radio networks, and Internet-based radio services networks.

The handset 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor 902 to facilitate wired and/or wireless serial communications (e.g., USB, and/or IEEE 994) through a hardwire connection, and other serial input devices (e.g., a keyboard, keypad, and mouse). This supports updating and troubleshooting the handset 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The handset 900 can include a slot interface 918 for accommodating a SIC (Subscriber Identity Component) in the form factor of a card Subscriber Identity Module (SIM) or universal SIM 920, and interfacing the SIM card 920 with the processor 902. However, it is to be appreciated that the SIM card 920 can be manufactured into the handset 900, and updated by downloading data and software.

The handset 900 can process IP data traffic through the communication component 910 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 922 (e.g., a camera) can be provided for decoding encoded multimedia content. The video processing component 922 can aid in facilitating the generation, editing and sharing of video quotes. The handset 900 also includes a power source 924 in the form of batteries and/or an AC power subsystem, which power source 924 can interface to an external power system or charging equipment (not shown) by a power I/O component 926.

The handset 900 can also include a video component 930 for processing video content received and, for recording and transmitting video content. For example, the video component 930 can facilitate the generation, editing and sharing of video quotes. A location tracking component 932 facilitates geographically locating the handset 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touch screen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 938 when the Wi-Fi transceiver 913 detects the beacon of the access point. A SIP client 940 enables the handset 900 to support SIP protocols and register the subscriber with the SIP registrar server. The applications 906 can also include a client 942 that provides at least the capability of discovery, play and store of multimedia content, for example, music.

The handset 900, as indicated above related to the communications component 810, includes an indoor network radio transceiver 913 (e.g., Wi-Fi transceiver). This function supports the indoor radio link, such as IEEE 802.11, for the dual-mode GSM handset 900. The handset 900 can accommodate at least satellite radio services through a handset that can combine wireless voice and digital radio chipsets into a single handheld device.

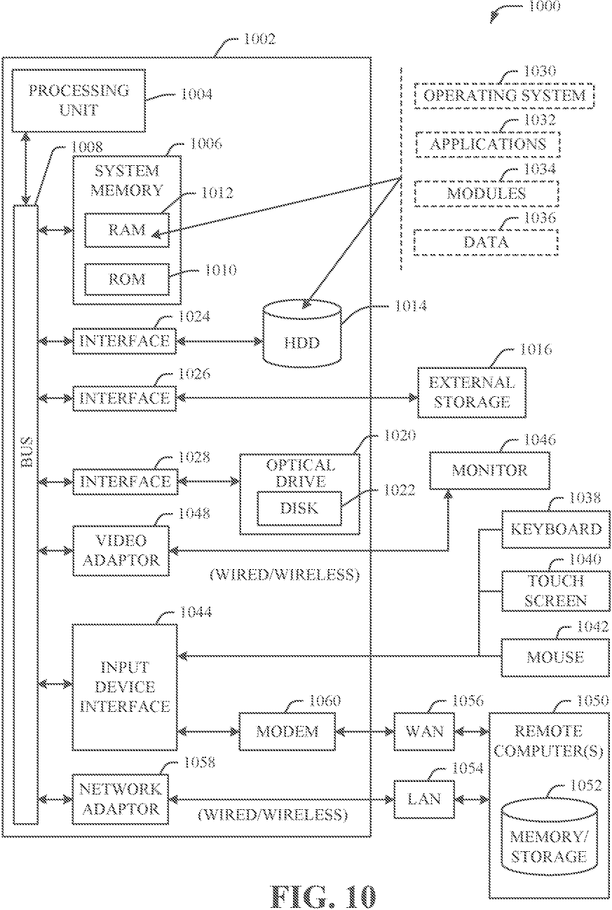

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD), non-volatile memory and other storage technology could be used in addition to, or in place of, an HDD 1014, and can be internal or external. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 994 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally include emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can include one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 994 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 10 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” “station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a processor; and
a memory that stores executable instructions that, when executed by the processor of the system, facilitate performance of operations, the operations comprising:
determining, based on millimeter wave-based position sensing of a mobile device, that a potential customer is at a location in front of a cabinet that is locked, wherein the mobile device is associated with the potential customer; and
executing an action, based on the determining that the potential customer is at the location, to facilitate providing assistance to the potential customer, wherein executing the action comprises:
transmitting a first command to a camera to activate the camera to capture a view of the potential customer, and
in response to determining, based on the view of the potential customer, that the potential customer is a legitimate customer attempting to access the cabinet, transmitting a second command to the cabinet to remotely control the cabinet to unlock the cabinet.

2. The system of claim 1, wherein executing the action further comprises selecting an advertisement based on the location, and sending the advertisement to the potential customer via at least one device, comprising the mobile device.

3. The system of claim 2, wherein the operations further comprise modifying the advertisement with at least one of: augmented reality data or virtual reality data.

4. The system of claim 1, wherein executing the action further comprises selecting a commercial sale enticement based on the location, and sending the commercial sale enticement to the potential customer via at least one device, comprising the mobile device.

5. (canceled)

6. The system of claim 1, wherein the mobile device is a first mobile device, and wherein executing the action further comprises transmitting a message to a second mobile device associated with a personal identity of a person, other than the potential customer, to instruct the person to proceed to the point-of-sale location to assist the potential customer.

7. The system of claim 1, wherein the operations further comprise, prior to executing the action, determining that the potential customer is remaining within a defined region proximate to the location for at least a defined length of time.

8. The system of claim 1, wherein the cabinet is within a store comprising multiple cabinets.

9. The system of claim 8, wherein the locked cabinet is associated with at least one of: a service or a brand of products.

10. (canceled)

11. The system of claim 1, wherein the operations further comprise determining a customer identity associated with the mobile device of the potential customer, and wherein executing the action further comprises customizing the action based on the customer identity of the potential customer.

12. The system of claim 11, wherein customizing the action based on the customer identity of the potential customer comprises customizing the action based on at least one of: spending history data representative of a spending history of the potential customer, status level data representative of a status level of the potential customer, membership data representative of a membership or membership level of the potential customer, prior behavior data representative of a prior behavior of the potential customer, or detected mannerism data representative of a detected mannerism of the potential customer.

13. The system of claim 1, wherein determining that the potential customer is at the location comprises receiving location data from a program executing on the mobile device of the potential customer.

14. (canceled)

15. A method, comprising:
determining, by a system comprising a processor, via millimeter wave-based position sensing of a mobile device, that the mobile device is proximate to a location in front of a cabinet that is locked;
obtaining, by the system, identity data associated with the mobile device;
accessing, by the system, commercial data associated with the location and the identity data; and
initiating, by the system based on the commercial data, an action to facilitate a providing assistance to a potential customer associated with the mobile device, wherein the action comprises:
transmitting a first instruction to a camera to activate a video camera having a view of the potential customer, and
in response to determining, based on the view of the potential customer, that the potential customer is a legitimate customer attempting to access the cabinet, transmitting a second instruction to the cabinet that remotely unlocks the cabinet.

16. The method of claim 15, wherein accessing the commercial data associated with the location and the identity data comprises selecting at least one of: an advertisement or a coupon based on the location and the identity data, and wherein the action further comprises sending the at least one of the advertisement or the coupon to the mobile device.

17. (canceled)

18. The method of claim 15, further comprising determining, by the system, based on a length of time that the mobile device is proximate the location, that the mobile device is associated with a threshold probability of the potential customer being the legitimate customer.

19. A non-transitory machine-readable medium, comprising executable instructions that, when executed by a processor of network equipment, facilitate performance of operations, the operations comprising:
detecting, via mobile device millimeter wave-based position sensing of a mobile device, presence of the mobile device proximate a location for an amount of time that satisfies a defined length of time criterion, wherein the location is in front of a merchandise counter that is locked; and
based on the presence of the mobile device, performing an action to facilitate providing assistance to a potential customer associated with the mobile device, wherein performing the action comprises:
transmitting a first message to a camera to activate the camera to capture a view of the potential customer, and
in response to determining, based on the view of the potential customer, that the potential customer is a legitimate customer attempting to access the merchandise counter, sending a second message to the merchandise counter that remotely unlocks the merchandise counter.

20. The non-transitory machine-readable medium of claim 19, wherein the operations further comprise determining, from a group of zones respectively associated with different brands, that the location is in a zone associated with a brand represented by a brand representative.

21. The non-transitory machine-readable medium of claim 20, wherein performing the action further comprises selecting an advertisement based on the brand, and sending the advertisement to the potential customer via at least one device, comprising the mobile device.

22. The non-transitory machine-readable medium of claim 20, wherein performing the action further comprises selecting a commercial sale enticement based on the brand, and sending the commercial sale enticement to the potential customer via at least one device, comprising the mobile device.

23. The non-transitory machine-readable medium of claim 20, wherein the mobile device is a first mobile device, and performing the action further comprises sending a communication to a second mobile device associated with the brand representative, other than the potential customer, to instruct the brand representative to proceed to the location to facilitate providing the assistance to the potential customer.

24. The method of claim 15, wherein mobile device is a first mobile device, and the action further comprises transmitting a communication to a second mobile device associated with a customer support representative, other than the potential customer, to instruct the customer support representative to proceed to the location to facilitate providing the assistance to the potential customer.
